(19) United States
(12) Patent Application Publication
(10) Pub. No.: US 2011/0050577 A1
(43) Pub. Date: Mar. 3, 2011

(54) WIRELESS PERIPHERAL DEVICE AND PRODUCTION MATCHING SYSTEM THEREOF

(75) Inventors: Yi-Ping Hsu, Jhonghe City (TW); Tao-Cheng Yen, Sanchong City (TW); Er-Hao Chen, Tucheng City (TW)

(73) Assignees: SILITEK ELECTRONIC (GUANGZHOU) CO., LTD., Guangzhou (CN); LITE-ON TECHNOLOGY CORPORATION, Taipei City (TW)

(21) Appl. No.: 12/643,906

(22) Filed: Dec. 21, 2009

(30) Foreign Application Priority Data
Aug. 27, 2009 (CN) 200910169633.4

(51) Int. Cl. G06F 3/02; H04B 7/00

(52) U.S. Cl. 345/168; 455/41.3

(57) ABSTRACT

Provided is a wireless peripheral device. Preferably the wireless peripheral device includes an operating main body and a receiver. The operating main body particularly has a controlling unit having built-in identification code. This identification code is particularly stored in a non-volatile memory of the controlling unit. The receiver, corresponding to the operating main body, pre-stores the matched identification code. The receiver acquires the power supplied from a computer system as connected therewith. Automatically, the operating main body and the receiver are wirelessly connected in accordance with the identification code. It is featured that the cost of the wireless peripheral device can be effectively reduced, and the related matching procedure can also be simplified before factory shipment.

### BACKGROUND OF THE INVENTION

1. Field of the Invention

The present invention generally relates to a wireless peripheral device, more particularly, to the wireless peripheral device with low cost and without any matching procedure, and its relevant production matching system.

2. Description of Related Art

With accelerating development of science, the wireless communication technology is widespread and applicable to the human daily life. To the computer peripherals, such as keyboard, computer mouse, presentation pointer, and gaming control device, most of them are utilizing the wireless communication technology to process the data transmission with the computer system. Those applications are placing emphasis on the advantages of reducing occupied space, and increasing convenience.

The wireless peripheral device is designed to have a transmitter and a receiver. The transmitter is a wireless operating device provided to a user's operation, and the receiver is essentially a Dongle for connecting to a computer system. This wireless receiver can be a receiver with USB used for connecting with the computer system via USB. Thereby, the wireless operating device and the wireless receiver are wirelessly communicated. In order to keep normal operation to the wireless communication, a matching procedure should be incorporated between the wireless operating device and the wireless receiver. Through this matching procedure, the wireless operating device and the receiver can have an identical identification code (ID) for successfully processing the wireless communication there-between.

In hardware design, an extra electronic programmable EEPROM is designed for the wireless operating device and the receiver. The EEPROM in the wireless operating device is used to store a pre-given identification code, which is provided for the matching procedure to be accessed by the wireless receiver. Therefore, the wireless operating device and the wireless receiver can process the wireless communication based on the identification code stored in each EEPROM.

In practical operation, while a user initially connects the wireless receiver to the computer system and switches on the wireless operating device, two link buttons set on both the wireless operating device and the receiver need to be pressed (activated) for processing the matching procedure.

### SUMMARY OF THE INVENTION

In view of foregoing shortcoming to be solved, one object of the present invention is to provide a technical improvement to reduce the substantial elements of a wireless peripheral device. An identification code matching procedure between an operating main body and a receiver of the wireless peripheral device is accomplished before factory shipment. Therefore, when a user is manipulating the wireless peripheral device, the wireless communication between the body and the receiver is automatically processed according to the matched identification code.

According to one aspect of the invention, a production matching system of the wireless peripheral device is particularly provided, comprising a wireless peripheral device, and a reader. The wireless peripheral device further includes an operating main body and a receiver as described above. This operating main body includes a controlling unit having a built-in identification code. The identification code is stored in a non-volatile memory of the controlling unit. The receiver is connected to the computer system.

Further, the reader is connected with the computer system and the operating main body to read the identification code of the controlling unit. The recognized identification code is then transferred to the computer system. Next, a programming procedure is performed after the computer system receives the identification code, and the procedure is used to program the identification code into the receiver. After that, the identification code corresponding to the operating main body can be stored in the receiver.

According to another aspect of the invention, the claimed wireless peripheral device includes an operating main body and a receiver. The operating main body includes a controlling unit with a built-in identification code. The identification code is stored in the non-volatile memory therein. The receiver stores the identification code in accordance with the operating main body. The operating main and the receiver will be wirelessly inter-communicated based on the identification code whenever the receiver is powered-up by connecting to the computer system.

The achievements of the present invention are to effectively reduce the cost of the wireless peripheral device, and also to simplify user's pre-operation procedure before manipulating the wireless peripheral device. Furthermore, the invention can minimize the possibility of disorder or nonfunctional identification code under interference when the wireless peripheral device is in use since the identical identification code of both operating main body and receiver is matched before factory shipment.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a block diagram of a wireless peripheral device of the present invention;

FIG. 2A shows a circuit diagram of an operating main body of a pointing device of the wireless peripheral device in accordance with the present invention;

FIG. 2B shows a circuit diagram of a receiver of the wireless peripheral device according to the present invention; and

FIG. 3 is a block diagram of a production matching system of the wireless peripheral device according to the present invention.

### DETAILED DESCRIPTION OF THE PREFERRED EMBODIMENTS

Disclosed here for the present invention is a wireless peripheral device, which stores an identification code with a controlling chip in each of its operating main body and receiver. Further, a matching procedure of the identification code between the operating main body and the receiver is processed before factory shipment. Therefore, the matched identification code is used for automatically processing wireless communication between the body and the receiver as a user is manipulating the wireless peripheral device in practice. Therefore, the user will not be required to utilize any link button to process the matching procedure beforehand since the matching procedure is accomplished before factory shipment. Moreover, neither the operating main body nor the receiver needs any link button and extra memory to store the identification code.

Further benefits arise through the fact that the present invention does not limit overall function or the embodiment to being simply a single operating main body matching one receiver. Many various types of the products relating to the wireless peripheral devices are encompassed within the scope of this invention which is defined completely solely within the claims found here later in this description. Packaged products relating to the wireless peripheral devices include a plurality of operating main bodies, such as keyboard, pointing device, presentation pointer, and gaming control device, and a corresponding receiver. In other words, a receiver can simultaneously and wirelessly connect with several operating main bodies. Therefore, a user may utilize various operating main bodies to manipulate the computer system. For the sake of convenience, the following description is embodied through one operating main body which corresponds to one receiver, and the operating main body is recognized in a manner such as pointing devices including the likes of a computer mouse or other functional equivalents.

Furthermore, the skilled person in the area of art which encompasses the present invention will be capable of understanding that currently prevalent wireless peripheral devices are most generally categorized into three frequency bands which are 27 MHz, 2.4 GHz, and Bluetooth. Taking into consideration of communication distance, interference, and cost, the frequency band 2.4 GHz is adopted by most manufacturers. The band 2.4 GHz is used in the following embodiment to be the wireless communication band between the operating main body and the receiver.

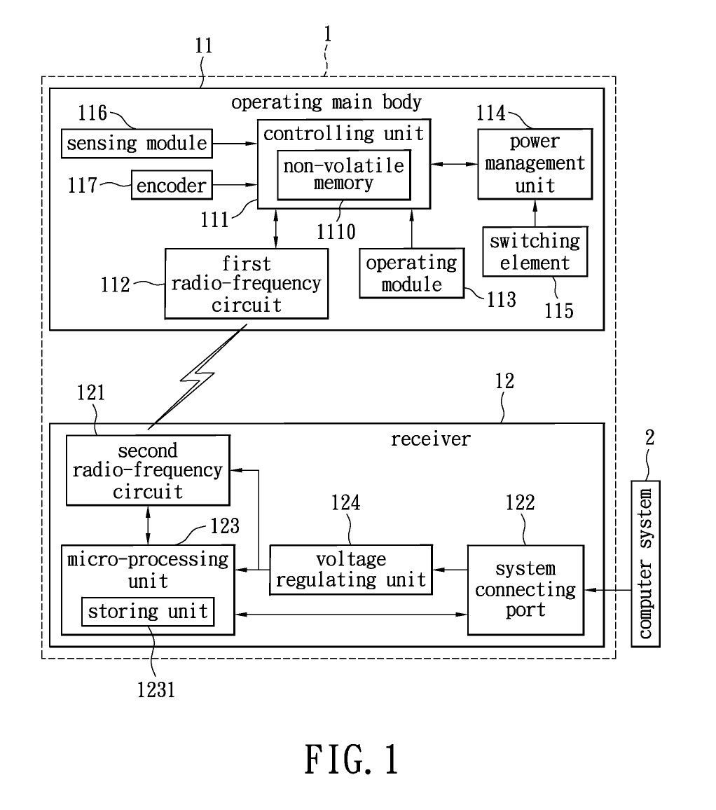

Reference is made to FIG. 1 showing a block diagram of the wireless peripheral device of one embodiment of the present invention. As shown in the diagram, the wireless peripheral device 1 in this embodiment is adapted to a computer system 2. The device 1 has an operating main body 11 and a receiver 12. The operating main body 11 includes a controlling unit 111 with a built-in identification code. The receiver 12 pre-stores the identification code of the corresponding operating main body 11. When the receiver 12 connects to the computer system 2 for receiving the power supplied by the computer system 2, the operating main body 11 and the receiver 12 are wirelessly communicated in accordance with the identification code.

According to the design of the device, the controlling unit 11 has a built-in non-volatile memory 1110 such as ROM, and another volatile memory (not shown) such as RAM for buffering the data as the controlling unit 111 is under operation. The firmware accompanied with the controlling unit 111 is pre-programmed into the controlling unit 111 as production. Particularly, the current embodiment incorporates this programming procedure in programming the identification code into the non-volatile memory 1110, and makes the controlling unit 111 have built in the identification code. Therefore, the operating main body 11 does not need any extra EEPROM for the controlling unit 111 to store the code.

On the other hand regarding the receiver 12, the identification code is programmed into the receiver 12 as reading the identification code corresponding to the operating main body 11 during the production stage. After that, the receiver 12 can preset the identification code of the operating main body 11, and the matching procedure between the operating main body 11 and the receiver 12 is accomplished before factory shipment. The detailed description of the mentioned reading and programming steps in the production stage can refer to the following disclosure.

The identification code built in the controlling unit 111 can be generated within a certain coding range in accordance with a sequential and progressive manner or set of parameters. Some other ways are also applicable, such as to be a randomly generated number. The major purpose is to make sure that every controlling unit 111 has a unique identification code in order to prevent any interference when two or more wireless peripheral devices are simultaneously operating.

As an example of the present invention, one operating main body 11 to match another one receiver 12 is provided in this embodiment. It is noted that singular identification code is used to accomplish the coding. However, if multiple operating main bodies 11 are companied with one receiver 12, their built-in identification codes are designed for various types in order to distinguish the different bodies 11. The receiver 12 is separately programmed with the identification codes of the different operating main bodies 11 during production so as to be successfully matched with each of the operating main bodies 11.

Besides the above-described way to generate the identification code for preventing any conflict between different main bodies and receivers, the other one scheme is further provided. This scheme is to build multiple frequency channels in the controlling unit 111 for preventing the interference caused by the external signals, such as the WLAN signal. The interference may make the operations of the operating main body 11 and receiver 12 unstable. For example, the wireless transmission is processed under the frequency band 2.4 GHz in the current embodiment, and then there are 78 sections of applicable channels between 2402 MHz and 2479 MHz.

The mentioned multiple frequency channels are selected from the 78 sections and built in the controlling unit 111. For example, the channels built in the controlling unit 111 include those selected from every relative high, middle and low frequency sections between 2402 MHz and 2479 MHz. Thus the controlling unit 111 of the operating main body 11 will perform a frequency-hopping process when the user manipulates the wireless peripheral device 1. Based on the built-in identification code, one of the built-in frequency channels is used to wirelessly communication with the receiver. The built-in scheme can prevent the interference caused by the ambient signals with similar frequency when the peripheral device 1 is in use.

The provided frequency-hopping process will firstly select one preset channel to carry out the wireless communication, but the frequency-hopping process is performed as the frequency interference happens. That is, one other channel is then selected to take over the wireless communication. Alternatively, one channel, which is randomly selected, is used to perform the wireless communication in the beginning. When the channel is interfered, the frequency-hopping process is performed. It is noted that there is no further restriction with regard to the design of frequency-hopping technology in the present invention.

Reference is made to the first type of frequency-hopping process. A user is using the wireless peripheral device 1 and the preset identification code of the device 1 is “01”. Furthermore, in the controlling unit 111 of the wireless peripheral device 1, the built-in frequency channels are around 2402 MHz, 2445 MHz and 2478 MHz, and the band 2402 MHz is a preset channel. In the meantime, if any stronger interference signal around 2402 MHz happens nearby, the wireless peripheral device 1 used by the user may be unstable or not functioned. In view of the event, the controlling unit 111 of the operating main body 11 of the wireless communication device 1 in the present invention performs the frequency-hopping process for selecting other built-in channel, such as band 2446 MHz or 2479 MHz. Therefore, the operating main body 11 can successfully continue to communicate with the receiver 12.

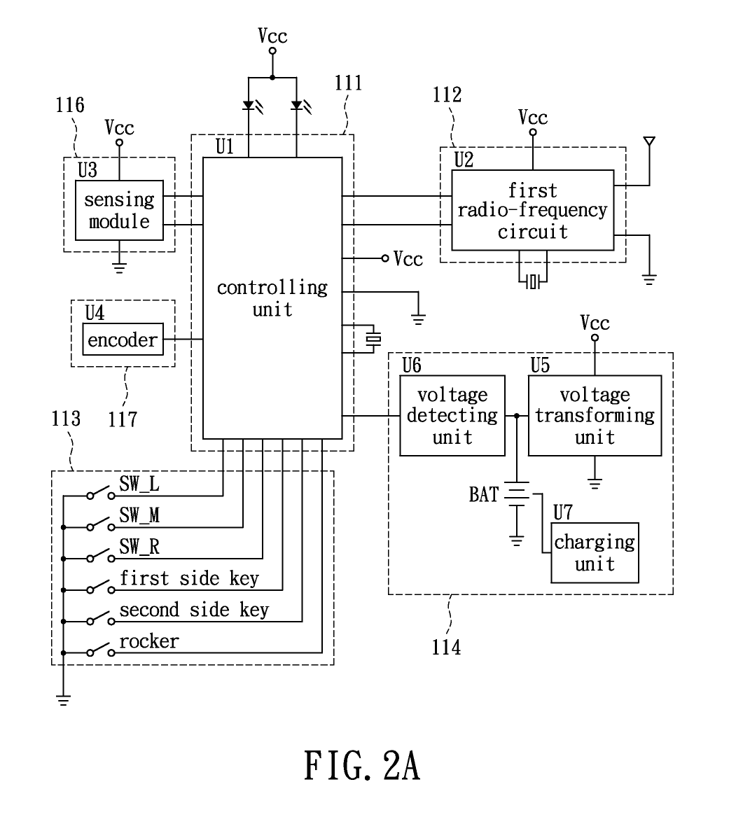

Reference is again made to FIG. 1, which illustrates the operating main body 11 of the pointing device matching with the receiver. The embodiment can further refer to the FIG. 2A and FIG. 2B, which are the circuit blocks depicting the operating main body of the pointing device of the wireless peripheral device and the receiver respectively.

The operating main body 11, besides the controlling unit 111, further includes a first radio-frequency circuit 112, an operating module 113, a power management unit 114, a switching element 115, a sensing module 116, and an encoder 117. The first radio-frequency circuit 112 is the radio-frequency circuit designed with 2.4 GHz, which is electrically connected to the controlling unit 111. The first radio-frequency circuit 112, which preferably operates at band 2.4 GHz, is wirelessly connected with the receiver 12 and electrically connected to the controlling unit 111 for signaling between the controlling unit 111 and the receiver 12.

The operating module 113 is electrically connected with the controlling unit 111. The module 113 is further equipped with a plurality of operating keys (not shown) for users' keystroke. If any operating key is triggered as any user' keystroke is received, a functional signal will be generated and forwarded to the controlling unit 111 in order to acquire the pressed operating key Since the current embodiment is depicting the operating main body of the pointing device, FIG. 2A shows the circuitry of operating keys of the common pointing device. However the shown quantity and provided function of the operating keys are in accordance with the design of the operating main body 11 in practice, and are not intended to limit the scope of the present invention. For example, if the operating main body 11 indicates the body of a keyboard, the operating keys of the operating module 113 are the keys equipped on the keyboard.

It is featured that the operating module 113 of the current embodiment does not need any link key according to the present invention.

Furthermore, the power management unit 114 provides the power supplied for the operation of the operating main body 11. As shown in FIG. 2A, the power management unit 114 further includes a charging battery (BAT), a voltage transforming unit (U5), a voltage detecting unit (U6), a charging unit (U7) and the peripheral circuit elements. The related operating principle and function can be understood by the ordinary skilled person in the art, and thus the details will not be given.

The switching element 115 is electrically connected to the power management unit 114. The switching element 115 is one type of the mechanical components, and it is provided for the user to process switching for generating a switching signal. This signal is particularly used to control on/off status of the power management unit 114. That is, when the user uses the wireless peripheral device 1, the switching element 115 is switched on so that the power management unit 114 can supply power to the whole operating main body 11. When the user does not use the wireless peripheral device 1, the switching element 115 is switched off, and the power management unit 114 stops supplying power at the moment.

The sensing module 116 is electrically connected to the controlling unit 111 for sensing and generating a displacement coordinate signal to the controlling unit 111. The displacement coordinate signal is used as a displacement control signal for the pointing device.

Moreover, the encoder 117 is electrically connected to the controlling unit 111. A roller member (not shown) disposed with the operating main body of the pointing device is collocated with the encoder 117, in order to generate an encoding signal to the controlling unit 111. This encoding signal is used as a motion signal for the roller member.

On the other hand, the mentioned receiver 12 includes a second radio-frequency circuit 121, a system connecting port 122, a micro-processing unit 123, and a voltage regulating unit 124. The second radio-frequency circuit 121 is implemented as a 2.4 GHz radio-frequency circuit, and used for wirelessly connecting to the first radio-frequency circuit 112. Moreover, the system connecting port 122 is electrically connected to the computer system 2 for receiving a system voltage provided by the computer system 2. The port 122 is used as a signal transmitted between the receiver 12 and the computer system 2. Reference is made to FIG. 2B, the system connecting port 122 is the USB exemplarily disposed in the computer system 2.

The micro-processing unit 123 is electrically connected to the second radio-frequency circuit 121 and the system connecting port 122. Further, the unit 123 has a built-in storing unit 1231 which pre-stores the identification code corresponding to the operating main body 11. That is, at production stage, the identification code is read out from the operating main body 11 and is programmed into the storing unit 1231 of the micro-processing unit 123.

The voltage regulating unit 124 is electrically connected to the system connecting port 122, the second radio-frequency circuit 121 and the micro-processing unit 123. The voltage regulating unit 124 is used to receive the system voltage and to transform the system voltage into an operating voltage for operations of the second radio-frequency circuit 121 and the micro-processing unit 123.

Thus when the receiver 12 is connected to the computer system 2 for receiving the power supplied by the computer system 2 to operate, the micro-processing unit 123 can control the second radio-frequency circuit 121 to process the wireless communication according to the identification code stored in the storing unit 1231.

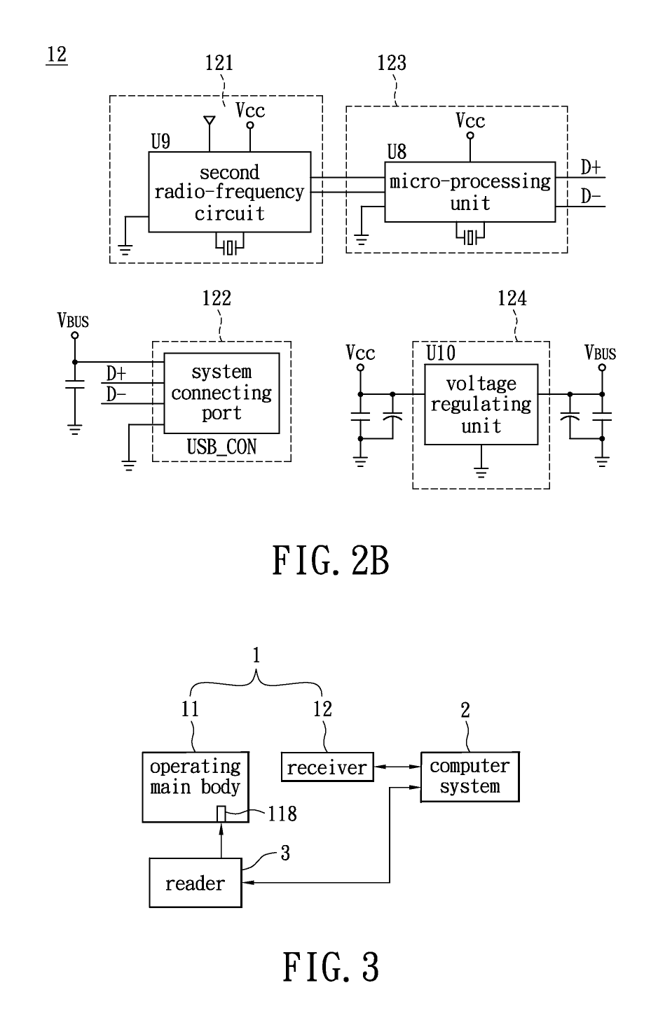

Reference is made to FIG. 3, which illustrates a block diagram of the production matching system of the wireless peripheral device of the present invention. As the foregoing description, the identification code of the operating main body 11 is programmed into the receiver 12 during production stage. The programmed identification code makes the receiver 12 reach a state of matching in advance. In other words, the programming procedure is accomplished before factory shipment of the wireless peripheral device 1. As shown in the diagram, the matching system of pre-defined identification code includes a wireless peripheral device 1, a computer system 2, and a reader 3. The receiver 12 of the wireless peripheral device 1 is connected to the computer system 2, and the reader 3 is also connected to the computer system 2. As an example, both the reader 3 and the receiver 12 are connected to the computer system 2 via the USB connectors. The practical implementation is not limited to the current embodiment.

Furthermore, the operation main body 11 of the claimed wireless peripheral device 1 is designed to reserve a test pin 118 which is electrically connected with the controlling unit 111. The test pin 118 can be a contact point or connecting pin reserved on the circuit board (not shown in the diagram) of the operating main body 11. The test pin 118 is designed for connecting the reader 3, and the reader 3 can read out the identification code built in the controlling unit 111 via the test pin 118.

When the reader 3 acquires the identification code, and transfers it to the computer system 2, the computer system 2 then performs a programming procedure. The procedure makes the identification code be programmed into the receiver 12. Thereby, the operating main body 11 of the wireless peripheral device 1 and the corresponding receiver 12 have the same identification codes before factory shipment and a steady matching status is formed there-between.

In summation of above description, before factory shipment of the claimed wireless peripheral device, its operating main body and the receiver have accomplished the matching procedure. The user only needs to make the operating main body of wireless peripheral device under an operation status, and to link the receiver connected to the computer system. After that, the operating main body and the receiver are automatically communicated with each other based on the matched identification codes. It is beneficial that the link key between the operating main body and the receiver can be reduced, and the additional EEPROM in the controlling unit used to store the identification code can be reduced as well. Therefore, it is effective to reduce the cost of the wireless peripheral device. Moreover, the invention further prevents the problem for the user to operate the matching procedure. Still further, any possibility of disorder or nonfunctional identification code caused by interference there-between can be avoided since the operating main body and the receiver have been matched using the same identification code before factory shipment.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A wireless peripheral device, comprising: an operating main body having a controlling unit with a built-in identification code stored in a non-volatile memory of the controlling unit; and a receiver corresponding to the operating main body and pre-storing the built-in identification code; wherein the operating main body and the receiver are automatically communicated wirelessly in accordance with the identification code while the receiver connects to a computer system.

2. The device of claim 1, wherein the controlling unit further includes multiple frequency channels, and the controlling unit performs a frequency-hopping process to select one of the channels to wirelessly communicate with the receiver.

3. The device of claim 2, wherein the operating main body is the one selected from a keyboard, a pointing device, a presentation pointer, and a gaming control device.

4. The device of claim 2, wherein the operating main body further includes a test pin electrically connected with the controlling unit and used for transmitting the identification code to a reader connected to the test pin.

5. The device of claim 2, wherein the operating main body further comprises: a first radio-frequency circuit, electrically connected to the controlling unit and wirelessly connected to the receiver, and used for transmitting signal between the controlling unit and the receiver; and an operating module, electrically connected to the controlling unit, and having a plurality of operating keys which generate corresponding functional signals to the controlling unit as a keystroke is received.

6. The device of claim 5, wherein the operating main body further comprises: a power management unit supplying power to the operating main body; and a switching element, electrically connected to the power management unit, used for generating a switching signal to control on/off status of the power management unit.

7. The device of claim 6, wherein the operating main body is the body of a pointing device, the body further comprising: a sensing module, electrically connected to the controlling unit, used for generating a displacement coordinate signal to the controlling unit; and an encoder, electrically connected to the controlling unit, used for generating an encoding signal to the controlling unit by collocating with a roller member of the body of the pointing device.

8. The device of claim 5, wherein the receiver further comprises: a second radio-frequency circuit wirelessly connected to the first radio-frequency circuit; a system connecting port electrically connected with the computer system; and a micro-processing unit, electrically connected to the second radio-frequency circuit and the system connecting port, pre-storing the identification code corresponding to the operating main body; wherein the micro-processing unit controls the second radio-frequency circuit according to the identification code to wirelessly communicate with the operating main body.

9. The device of claim 8, wherein the micro-processing unit has a built-in storing unit for storing the identification code.

10. The device of claim 8, wherein the receiver receives a system voltage supplied by the computer system via the system connecting port.

11. The device of claim 10, wherein the receiver further comprises a voltage regulating unit electrically connected to the system connecting port, the second radio-frequency circuit, and the micro-processing unit, for receiving the system voltage and converting the voltage into an operating voltage to the second radio-frequency circuit and the micro-processing unit.

12. The device of claim 1, wherein the operating main body further comprises: a first radio-frequency circuit, electrically connected with the controlling unit and wirelessly connected to the receiver, for transmitting signal between the controlling unit and the receiver; and an operating module, electrically connected to the controlling unit, having a plurality of operating keys which generate corresponding functional signals to the controlling unit as a keystroke is received.

13. The device of claim 12, wherein the operating main body further comprises: a power management unit supplying power to the operating main body; and a switching element, electrically connected to the power management unit, generating a switching signal for controlling on/off status of the power management unit.

14. The device of claim 13, wherein the operating main body is the body of a pointing device, wherein the body further comprises: a sensing module, electrically connected to the controlling unit, used for sensing a displacement coordinate signal and transmitting to controlling unit; and an encoder, electrically connected to the controlling unit, used for generating an encoding signal to the controlling unit by collocating with a roller member of the operating main body of the pointing device.

15. The device of claim 12, wherein the receiver further comprises: a first radio-frequency circuit electrically connected to the first radio-frequency circuit; a system connecting port electrically connected to the computer system; and a micro-processing unit, electrically connected to the second radio-frequency circuit and the system connecting port, pre-storing the identification code with corresponding the operating main body; wherein the micro-processing unit controls the second radio-frequency circuit to wirelessly communicated with the operating main body according to the identification code.

16. The device of claim 15, wherein the receiver receives a system voltage of the computer system via the system connecting port, and the micro-processing unit of the receiver has a built-in storing unit for storing the identification code.

17. The device of claim 16, wherein the receiver further comprises a voltage regulating unit electrically connected to the system connecting port, the second radio-frequency circuit, and the micro-processing unit, for receiving the system voltage and converting the system voltage into an operating voltage to the second radio-frequency circuit and the micro-processing unit.

18. A production matching system of a wireless peripheral device, comprising: a computer system; a wireless peripheral device comprising: an operating main body having a controlling unit with a built-in identification code, wherein the identification code is stored in a non-volatile memory of the controlling unit; and a receiver connected to the computer system; a reader, connected to the computer system and the operating main body, used for reading out the identification code of the controlling unit from the operating main body, and transmitting the identification code to the computer system; wherein the computer system receives the identification code and performs a programming procedure for programming the identification code into the receiver, and the receiver has the identification code corresponding to the operating main body.

19. The system of claim 18, wherein the operating main body is the one selected from a keyboard, a pointing device, a presentation pointer, and a gaming control device.

20. The system of claim 18, wherein the operating main body further comprises: a test pin electrically connected to the controlling unit; whereby the reader connected with the test pin reads out the identification code through the test pin.
